(19) United States
(12) Patent Application Publication
(10) Pub. No.: US 2016/0111219 A1
(43) Pub. Date: Apr. 21, 2016

(54) METHOD FOR MANUFACTURING ELECTRONIC COMPONENT

(71) Applicant: Murata Manufacturing Co., Ltd., Kyoto-fu (JP)

(72) Inventor: Osamu YOKOKURA, Nagaokakyo-shi (JP)

(73) Assignee: Murata Manufacturing Co., Ltd., Kyoto-fu (JP)

(21) Appl. No.: 14/972,792

(22) Filed: Dec. 17, 2015

Related U.S. Application Data
(63) Continuation of application No. PCT/JP2014/064547, filed on May 31, 2014.

(30) Foreign Application Priority Data
Jun. 28, 2013 (JP) 2013-136046

(51) Int. Cl. H01G 9/00; H01G 4/005; H01G 4/12; H01G 9/04

(52) U.S. Cl. CPC H01G 9/0029; H01G 9/04; H01G 4/005; H01G 4/12

(57) ABSTRACT

A method for forming a conductor film, which allows the reduction in the thickness of a conductor film formed for an electronic component, and can form, at once, conductor films continuously extending over first and second surfaces of an electronic component which intersect one another. A component body is disposed to be opposed to a discharge nozzle for discharging an coating material which serves as a material for a conductor film, and the coating material charged by applying a voltage between the discharge nozzle and the component body (2) is discharged from the discharge nozzle. The charged coating material is applied to the component body along lines of electric force.

### CROSS REFERENCE TO RELATED APPLICATIONS

This application claims benefit of priority to Japanese Patent Application 2013-136046 filed Jun. 28, 2013, and to International Patent Application No. PCT/JP2014/064547 filed May 31, 2014, the entire content of which is incorporated herein by reference.

### TECHNICAL FIELD

This disclosure relates to a method for manufacturing an electronic component, and more particularly, to a method for forming a conductor film on the surface of a component body included in an electronic component.

### BACKGROUND

Electronic components generally include component bodies and conductor films formed on the component bodies. The conductor films function as terminal electrodes, function as electrodes for extracting electrical characteristics of the component bodies, or serve as both of the functions. In addition, the component bodies include various shapes, for example, such as a rectangular parallelepiped shape, a disc shape, and a foil shape. In addition, the conductor films formed on the component bodies are often formed to continuously extend over at least two surfaces of the component bodies which intersect one another.

To explain more specifically, FIG. 4 illustrates an electronic component 1 including a component body 2 in a rectangular parallelepiped shape. The component main body 2 has two principal surfaces 3 and 4 opposed to each other, two side surfaces 5 and 6 opposed to each other, and two end surfaces 7 and 8 opposed to each other. Two conductor films 9 and 10 are formed on the component body 2. One conductor film 9 is formed to continuously extend on one end surface 7, and portions for each of the principal surfaces 3 and 4 and side surfaces 5 and 6 which are adjacent to the end surface. The other conductor film 10 is formed to continuously extend on the other end surface 8, and portions for each of the principal surfaces 3 and 4 and side surfaces 5 and 6 which are adjacent to the end surface.

FIG. 5 illustrates an electronic component 11 including a component body 12 in a rectangular parallelepiped shape. The component body 12 has two principal surfaces 13 and 14 opposed to each other, two side surfaces 15 and 16 opposed to each other, and two end surfaces 17 and 18 opposed to each other. Six conductor films 19 to 24 are formed on the component body 12. Each of the first to third conductor films 19 to 21 is formed to continuously extend on one side surface 15, and portions for each of the two principal surfaces 13 and 14 which are adjacent to the side surface. Each of the fourth to sixth conductor films 22 to 24 is formed to continuously extend on the other side surface 16, and portions for each of the two principal surfaces 13 and 14 which are adjacent to the side surface.

FIG. 6 illustrates a component body 25 in a foil shape, which constitutes a capacitor element in an electrolytic capacitor, for example. FIG. 6 illustrates an entire electrolytic capacitor as an electronic component including the component body 25. The component body 25 has two principal surfaces 26 and 27 opposed to each other, and an end surface 28 for connecting between the principal surfaces 26 and 27. A conductor film 29 is formed to continuously extend on the two principal surfaces 26 and 27 and the end surface 28 adjacent to the principal surfaces.

The conductor films 9 and 10, conductor films 19 to 24, and conductor films 29 mentioned above, when generalized, all have such a form as a conductor film 35 as shown in FIG. 7 or 8. The conductor film 35 has to be formed to continuously extend over first, second, and third surfaces 32, 33, and 34 of a component body 31.

It is often the case that the conductor film 35 mentioned above is formed in a way that a conductive paste is applied by, for example, a dipping method onto the component body 31, and baked, as described in, for example, Japanese Patent Application Laid-Open No. 4-263414. In the dipping method, the conductive paste is applied onto the component body 31 in a predetermined region in a way that the component body 31 is dipped toward the conductive paste, and then pulled up from the conductive paste.

When the dipping method is applied as described above, the conductor film 35 formed tends to have, in terms of thickness, bulges in the central parts on each of the first to third surfaces 32 to 34 as shown in FIG. 7, due to a surface tension that acts on the conductive paste. Therefore, the proportion of the thickness dimension of the conductor film 35 in an electronic component is increased, thereby interfering with reducing the size of, or lowering the profile of the electronic component.

On the other hand, lowering the viscosity of the conductive paste is conceivable as a method of further reducing the thickness of the conductor film 35. However, as the viscosity of the conductive paste is lower, it is more difficult to coat ridge parts 36 of the component body 31 with the conductive paste, and as a result, as shown in FIG. 8, the conductor film 35 formed may be cut at the ridge parts 36 of the component body 31, thereby degrading electrical characteristics of the electronic component. In addition, spreading out of the conductive paste may make the conductor film 35 out of shape, thereby leading to problems in mounting the electronic component or degrading electrical characteristics after the mounting.

It is to be noted that while the ridge part 36 of intersection between the first and second surfaces 32 with each other and the ridge part 36 of intersection between the second and third surfaces 33 and 34 with each other are illustrated to have acute angles in FIG. 8, the edges are actually often subjected to round chamfering. The above-mentioned problem of the conductor film 35 cut on the ridge parts 36 is inevitable, even when the ridge parts 36 are subjected to round chamfering as just described above.

From the foregoing, in the case of applying a dipping method to form the conductor film 35, the reduction in the thickness of the conductor film 35 is considered to be limited to approximately 20 μm in thickness. Therefore, it is difficult to further reduce the size of, or lower the profile of the electronic component, and it is also difficult to enhance the performance of the electronic component, for example, in the case of a multilayer ceramic capacitor, to increase the capacitance thereof.

It is to be noted that the problems mentioned above applies not only to cases of the conductor film 35 formed to continuously extend over the three surfaces 32 to 34 of the component body 31 which intersect one another as shown in FIGS. 7 and 8, but also to cases of a conductor film formed to continuously extend over two surfaces which intersect one another.

### SUMMARY

### Problem to be Solved by the Disclosure

Therefore, an object of this disclosure is to provide a method for manufacturing an electronic component, which is able to further reduce the thickness of the conductor film.

### Means for Solving the Problem

This disclosure is directed to a method for manufacturing an electronic component including: a component body including at least first and second surfaces intersecting one another; and a conductor film formed on the component body to continuously extend over at least the first surface and second surface, and in order to solve the technical problem mentioned above, the method is characterized by including the steps of: preparing a component body; preparing a fluid coating material containing a conductive material as a material for the conductor film; placing the component body to be opposed to a discharge nozzle for discharging the coating material; and with the coating material charged by applying a voltage between the discharge nozzle and the component body, discharging the coating material from the discharge nozzle and applying the charged coating material to the component body, thereby forming the conductor film containing the conductive material simultaneously to continuously extend over at least the first surface and second surface of the component body.

In the step of forming the conductor film as mentioned above, the charged coating material flies through the air along lines of electric force. During this flying, the coating material repeats fission due to coulomb repulsive force (Rayleigh fission). The surface area is increased each time the fission is repeated, thus accelerating the evaporation of a liquid component such as a fluxing material or a solvent in the coating material. As a result, the coating material is dried to the extent that the fluidity is almost lost, when the material adheres to the surface of the component body. Therefore, substantially no surface tension acts on the coating material, but the coating material is thus not concentrated on any specific part, and thereby can be applied uniformly to be thin on at least first and second surfaces of the component body.

The manufacturing method according to this disclosure can be applied to electronic components in various forms.

As a first example of the electronic component, there is an electronic component where the component body has a rectangular parallelepiped shape including two principal surfaces opposed to each other, two side surfaces opposed to each other, and two end surfaces opposed to each other, and in the step of forming the conductor film, the conductor film is formed to continuously extend on at least one of the end surfaces, and portions for each of the principal surfaces adjacent to the end surface and portions for each of side surfaces adjacent to the end surface.

As a second example of the electronic component, there is an electronic component where the component body has a rectangular parallelepiped shape including two principal surfaces opposed to each other, two side surfaces opposed to each other, and two end surfaces opposed to each other, and in the step of forming the conductor film, the conductor film is formed to continuously extend on at least one of the side surfaces, and portions for each of the two principal surfaces adjacent to the side surface.

As a third example of the electronic component, there is an electronic component where the component body has a foil shape including two principal surfaces opposed to each other and an end surface for connecting between the principal surfaces, and in the step of forming the conductor film, the conductor film is formed to continuously extend on at least one of the principal surfaces and the end surface adjacent to the principal surface.

In the practice of the manufacturing method according to this disclosure, it is preferable to prepare a mask that covers a region other than a region of the component body on which the conductor film is to be formed, and form the conductor film with the component body covered with the mask. Thus, without being affected by the properties of the coating material, conductor films can be formed with a high degree of pattern accuracy, and contributions can be made to the reduction in size for electronic components.

### Advantageous Effect of the Disclosure

According to this disclosure, in the step of forming the conductor film, the coating material flies along lines of electric force as described previously, and the uniform formation of the conductor film on both the first surface and the second surface can be thus achieved simultaneously by applying the coating material from one direction. In addition, the lines of electric force tend to be concentrated on, in particular, ridge parts at intersections between first and second surfaces of the component body, and conductor films can be formed to have appropriate film thicknesses, even including the ridge parts.

In addition, according to this disclosure, the conductor film including the conductive material can be formed to be as thin as described previously. Therefore, the reduced size or lowered profile of the electronic component can be achieved by the reduced thickness of the conductor film. On the other hand, in the case of maintaining the dimensions of the electronic component, the effective volume which can be occupied by the part other than the conductor film, that is, the effective volume which can be occupied by the component body that fulfills the function can be increased, thereby improving the performance of the electronic component.

When the electronic component is, for example, a multilayer ceramic capacitor, the volume of a part that produced electrostatic capacitance can be increased, and as a result, higher capacitance can be achieved. In addition, when the electronic component is, for example, a laminate-type aluminum electrolytic capacitor, the surface is composed of anodized aluminum foil, and a capacitor element with the conductor film formed on the surface can be reduced in thickness. Thus, the number of capacitor element laminated can be increased, and thereby the capacitance can be increased.

In addition, when the conductor film including the conductive material can be formed to be thin as described above, the material used for the formation of the conductor film can be reduced, and the cost of the electronic component as a product can be thus reduced.

In addition, according to this disclosure, as compared with the formation of conductor films by a dipping method, problems can be avoided such as wetting up and defectively coated ridge parts caused by the properties of the coating material in the dipping method.

### BRIEF DESCRIPTION OF THE DRAWINGS

FIG. 1 is a front view schematically illustrating a system for carrying out a step of forming a conductor film in a method for manufacturing an electronic component according to a first embodiment of this disclosure.

FIG. 2 is a perspective view illustrating an enlarged part around a component body 2 as shown in FIG. 1.

FIG. 3 is a perspective view corresponding to FIG. 2, which schematically illustrates a system for carrying out a step of forming a conductor film in a method for manufacturing an electronic component according to a second embodiment of this disclosure.

FIG. 4 is a perspective view illustrating a first configuration example of a conventional electronic component.

FIG. 5 is a perspective view illustrating a second configuration example of a conventional electronic component.

FIG. 6 is a perspective view illustrating a third configuration example of a conventional electronic component.

FIG. 7 is a cross-sectional view illustrating a conductor film 35 on a component body 31 for explaining a first problem of the conductor film 35 formed by applying a dipping method.

FIG. 8 is a cross-sectional view illustrating the conductor film 35 on the component body 31 for explaining a second problem of the conductor film 35 formed by applying the dipping method.

### DETAILED DESCRIPTION

A method for manufacturing an electronic component 1 including a component body 2 in a rectangular parallelepiped shape as shown in FIG. 4 will be described as a first embodiment of this disclosure. For manufacturing this electronic component 1, the component main body 2 is prepared first.

On the other hand, a fluid coating material containing a conductive material is prepared which serves as conductor films and 10. For example, besides metal powders such as silver, silver-palladium alloys, and coppers, conductive materials such as carbon, conductive ceramics, and conductive polymers can be used as the conductive material.

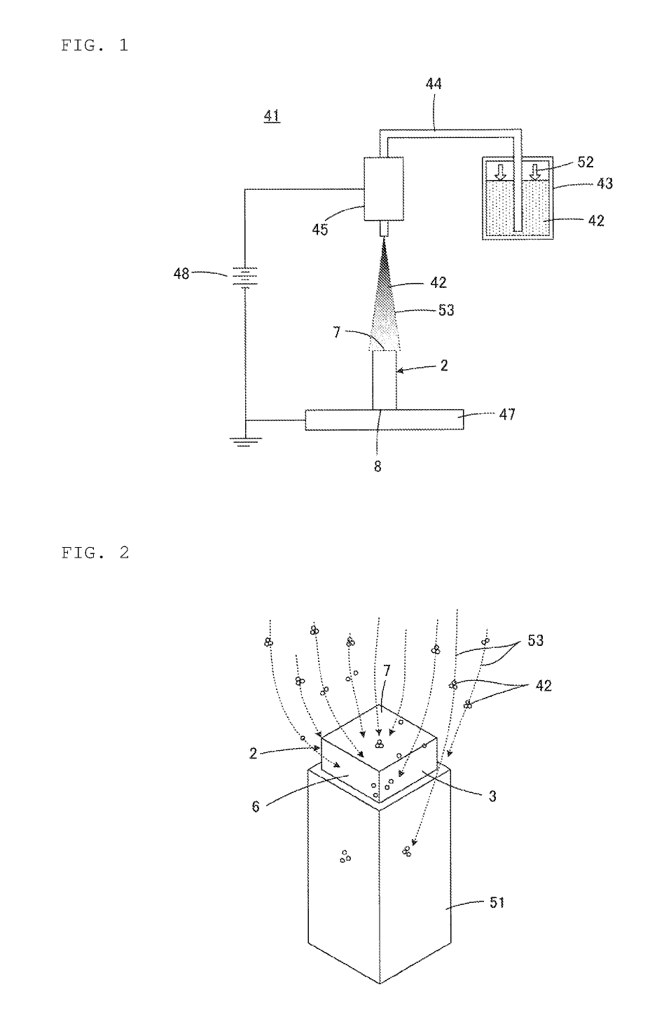

A conductor film formation system 41 shown in FIG. 1 is used in order to form conductors 9 and 10.

Referring to FIG. 1, the conductor film formation system 41 includes a storage tank 43 that contains the coating material 42 described above. The storage tank 43 is connected to discharge nozzle 45 through a supply pipe 44.

On the other hand, a stage 47 is provided to be opposed to the discharge nozzle 45, and the component body 2 as an object on which the conductor films 9 and 10 to be formed is placed on the stage 47. The stage 47 is preferably composed of a conductive material.

A pulse voltage, a direct-current voltage, or an alternating-current voltage from a power supply 48 is applied to the coating material 42 passing through the discharge nozzle 45.

As described above, steps of forming the conductor films 9 and 10 are carried out while the voltage is applied. It is to be noted that the step of forming the conductor film 9 and the step of forming the conductor film 10 are individually carried out in sequence. First, the step of forming the conductor film 9 will be described. In this embodiment, a region of the component body 2, except a region on which the conductor film 9 is to be formed, is covered with a mask 51 as shown in FIG. 2. In addition, an end surface 7 on which the conductor film 9 is to be formed is oriented to the discharge nozzle 45 as shown in FIG. 1.

In this condition, the internal pressure of the storage tank 43 is increased as indicated by arrows 52.

Thus, the coating material 42 in the storage tank 43 is supplied through the supply pipe 44 to the discharge nozzle 45 with the voltage applied thereto, thereby charging the coating material 42.

Lines of electric force 53 are generated from the charged coating material 42. The coating material 42 is discharged from the discharge nozzle 45 toward the component body 2.

The coating material 42 repeats (while flying through the air along the lines of electric force 53) fission due to coulomb repulsive force (Rayleigh fission), thereby turning into a spray. Accordingly, the coating material 42 further increases its surface area each time the fission is repeated, and thus, the coating material 42 is progressively dried to accelerate the evaporation of a liquid component such as a fluxing material or a solvent included in the coating material 42.

As a result, the coating material 42 is dried to the extent that the fluidity is almost lost, when the material adheres to the surface of the component body 2. Therefore, substantially no surface tension acts on the coating material 42, but the coating material 42 is thus not concentrated on any specific part of the component body 2, and thereby can be provided uniformly to be thin on the component body 2. FIG. 2 schematically illustrates the lines of electric force 53, which are generated by the charged coating material 42. The charged coating material 42 adheres to the component body 2 along the lines of electric force 53. In this regard, the lines of electric force 53 tend to be concentrated on, in particular, ridge parts of the component body 2, and the coating material 42 can be thus allowed to adhere uniformly, even including the ridge parts.

On the other hand, as shown in FIG. 2, the predetermined part of the component body 2 is covered with the mask 51, and thus, the coating material 42 will not reach the part of the component body 2, which is covered with the mask 51.

In this way, the thin conductor film 9 with a uniform thickness is formed with a high degree of pattern accuracy to continuously extend on one end surface 7 of the component body 2, and portions for each of the principal surfaces 3 and 4 and side surfaces 5 and 6 which are adjacent to the end surface.

Then, a step of applying heat treatment to the conductor film 9 is carried out.

Then, in order to form the other conductor film 10, the same step as the above-mentioned step of forming the conductor film 9 is repeated after reversing the orientation of the component body 2 on the stage 47, and attaching the mask 51 so as to cover a region except a region on which the conductor film 10 is to be formed.

Next, a step of applying heat treatment to the conductor film 10 is carried out as in the case of the conductor film 9.

It is to be noted that the heat treatment step mentioned above may be applied at once to both the conductor films 9 and 10 after the formation of the conductor films 9 and 10.

Based on the first embodiment described above, an experiment was carried out for forming the conductor films 9 and 10 on the component body 2.

As the coating material 42, a paste-like material of an Ag powder dispersed in an epoxy resin was used which was further provided with fluidity by the use of dipropylene methyl ether acetate so that the viscosity was 500 mPa·s at 1 rpm on an E-type viscometer.

The conductor films 9 and 10 were formed on the component body 2 with the use of the conductor film formation system 41 described with reference to FIGS. 1 and 2, and then subjected to heat treatment for 1 hour at a temperature of 150° C. in a circulating hot air oven.

In this way, when the conductor films 9 and 10 were formed for each thickness of 4 μm, 8 μm, 10 μm, 14 μm, 28 μm, 40 μm, and 100 μm, the conductor films 9 and 10 were able to be formed for each thickness, but the conductor films 9 and 10 were not found to be cut at ridge parts.

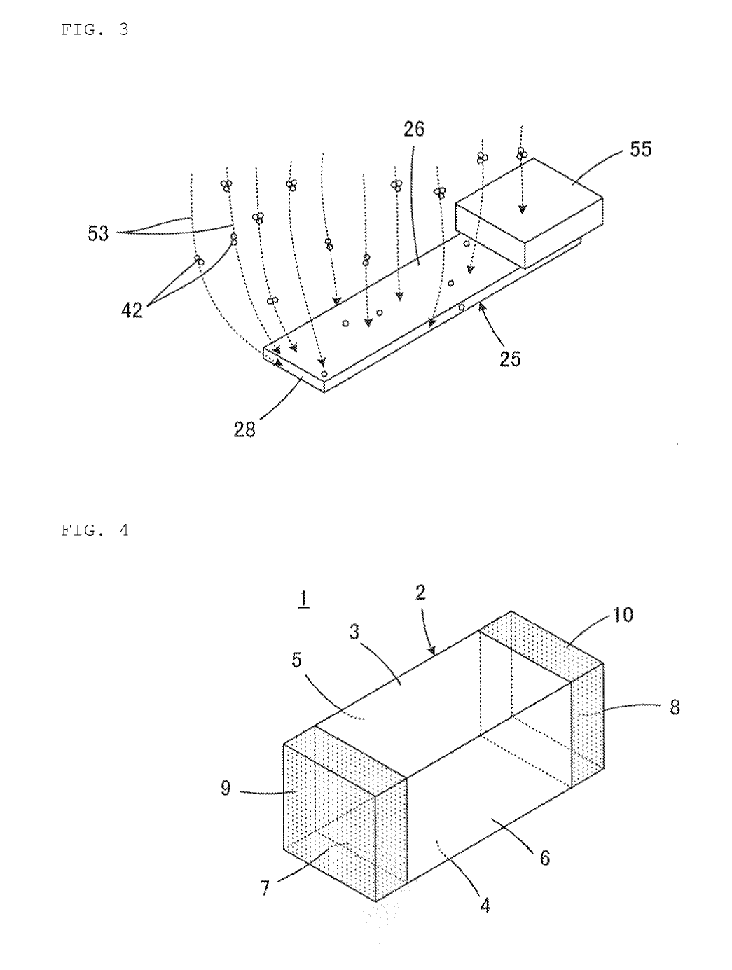

Next, a second embodiment of this disclosure will be described with reference to FIG. 3. In this embodiment, a conductor film 29 is formed a component body 25 in a foil shape as shown in FIG. 6.

The conductor film formation system 41 shown in FIG. 1 is used also in the second embodiment. In the second embodiment, as shown in FIG. 3, the component body 25 with a mask 55 attached thereto is placed on the stage 47 shown in FIG. 1.

Referring to FIG. 3, a charged coating material 42 adheres to the component body 25 along lines of electric force 53. In this regard, the lines of electric force 53 tend to be concentrated on, in particular, ridge parts of the component body 25, and the coating material 42 can be thus allowed to adhere uniformly, even including the ridge parts. On the other hand, the predetermined part of the component body 25 is covered with the mask 55, and thus, the coating material 42 will not reach the part of the component body 25, which is covered with the mask 55.

In this way, a part of the thin conductor film 29 with a uniform thickness is formed with a high degree of pattern accuracy to continuously extend on one end surface 26 of the component body 25, and the end surface 28 which is adjacent to the end surface.

Next, in order to form the rest of the conductor film 29, the same step as the step described above is repeated after reversing the orientation of the component body 25 on the stage 47.

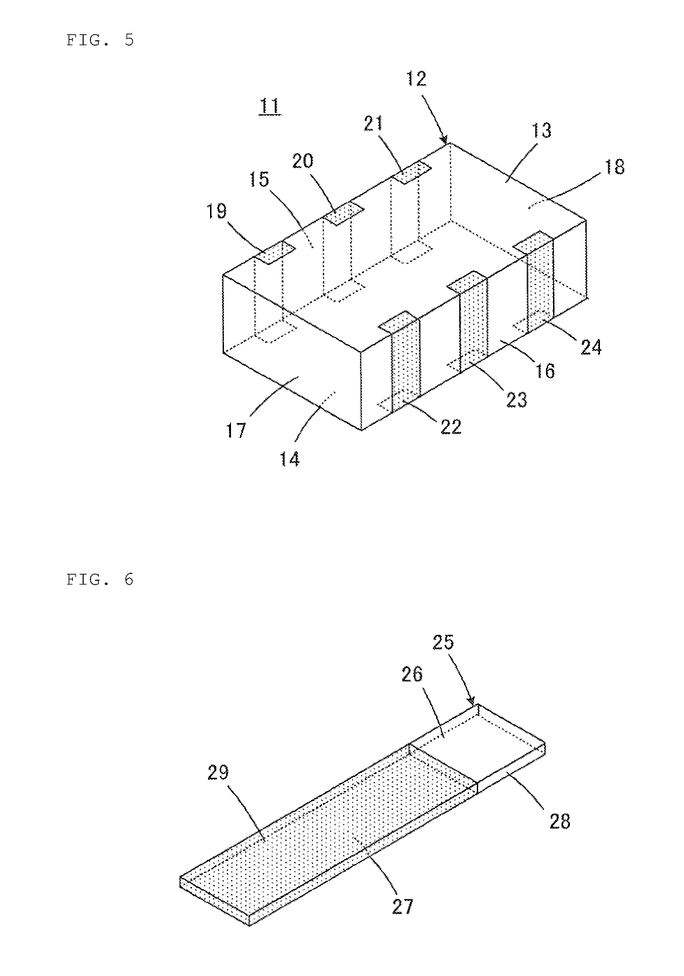

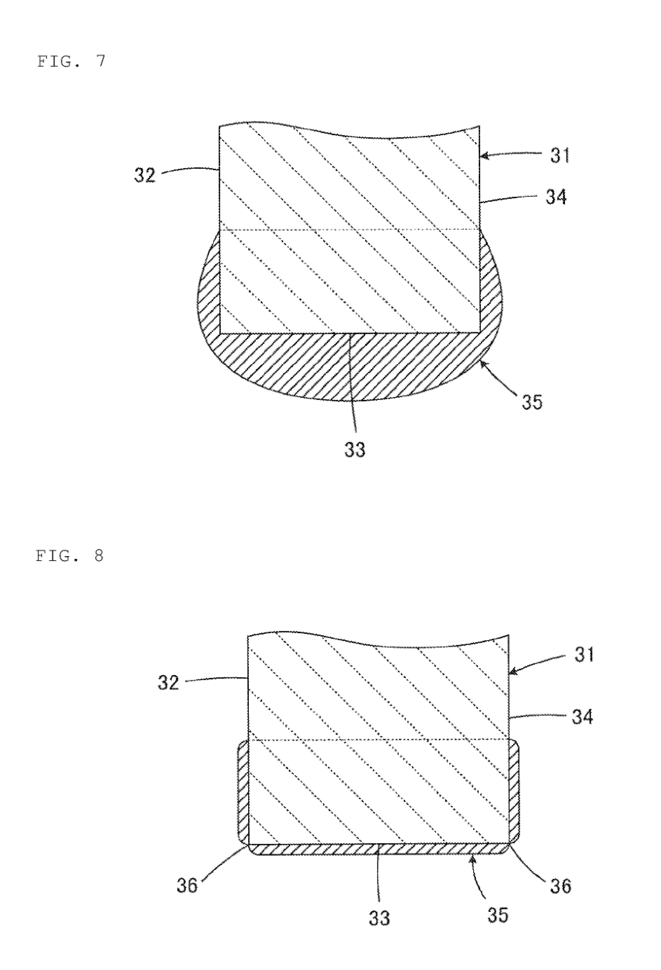

While this disclosure has been described above in connection with the first and second embodiments illustrated, the conductor film formation system 41 shown in FIG. 1 can be also applied in a step of forming the conductor films 19 to 24 on the component body 12, for example, in manufacturing the electronic component 11 shown in FIG. 5. Furthermore, for the electronic components including component bodies that have configurations other than the component bodies 2, 12, and 25 shown in FIGS. 4 through 6, or for electronic components including conductor films other than the conductor films 9 and 10, the conductor films 19 to 24, and the conductor film 29, the conductor film formation system 41 shown in FIG. 1 can be used in steps of forming the conductor films on the component bodies.

1. A method for manufacturing an electronic component comprising a component body including at least first and second surfaces intersecting one another; and a conductor film formed on the component body to continuously extend over at least the first surface and second surface,
the method comprising the steps of:
preparing a component body;
preparing a fluid coating material containing a conductive material as a material for the conductor film;
placing the component body to be opposed to a discharge nozzle for discharging the coating material; and
with the coating material charged by applying a voltage between the discharge nozzle and the component body, discharging the coating material from the discharge nozzle and applying the charged coating material to the component body, thereby forming the conductor film containing the conductive material simultaneously to continuously extend over at least the first surface and second surface of the component body.

2. The method for manufacturing an electronic component according to claim 1, wherein the component body has a rectangular parallelepiped shape including two principal surfaces opposed to each other, two side surfaces opposed to each other, and two end surfaces opposed to each other, and in the step of forming the conductor film, the conductor film is formed to continuously extend on at least one of the end surfaces, and portions for each of the principal surfaces adjacent to the end surface and portions for each of side surfaces adjacent to the end surface.

3. The method for manufacturing an electronic component according to claim 1, wherein the component body has a rectangular parallelepiped shape including two principal surfaces opposed to each other, two side surfaces opposed to each other, and two end surfaces opposed to each other, and in the step of forming the conductor film, the conductor film is formed to continuously extend on at least one of the side surfaces, and portions for each of the two principal surfaces adjacent to the side surface.

4. The method for manufacturing an electronic component according to claim 1, wherein the component body has a foil shape including two principal surfaces opposed to each other and an end surface for connecting between the principal surfaces, and in the step of forming the conductor film, the conductor film is formed to continuously extend on at least one of the principal surfaces and the end surface adjacent to the principal surface.

5. The method for manufacturing an electronic component according to claim 1, the method further comprising a step of preparing a mask that covers a region of the component body other than a region on which the conductor film is to be formed,
wherein the step of forming the conductor film is carried out with the component body covered with the mask.
